(19) United States
(12) Patent Application Publication
(10) Pub. No.: US 2012/0293566 A1
(43) Pub. Date: Nov. 22, 2012

(54) DIMMING DEVICE AND IMAGE DISPLAY DEVICE

(75) Inventors: Hideki Uchida, Osaka-shi (JP); Tsuyoshi Kamada, Osaka-shi (JP); Hidefumi Yoshida, Osaka-shi (JP); Satoshi Shibata, Osaka-shi (JP)

(73) Assignee: SHARP KABUSHIKI KAISHA, Osaka-shi, Osaka (JP)

(21) Appl. No.: 13/518,950

(22) PCT Filed: Oct. 28, 2010
(86) PCT No.: PCT/JP2010/069176

§ 371 Date: Jun. 25, 2012

(30) Foreign Application Priority Data
Jan. 6, 2010 (JP) 2010-001298

(51) Int. Cl. G09G 5/00; H05B 37/02

(52) U.S. Cl. 345/690; 315/360; 315/312

(57) ABSTRACT

Provided is a dimming device capable of emitting light from any area on a flat plane and which is minimized in crosstalk. The dimming device (1) according to the present invention includes: a light guiding plate (2); an LED (3) disposed on an edge of the light guiding plate (2); a switching section (4); a frame division section (5) that divides one frame period into a plurality of sub frame periods; a light source control section (6) that makes the LED (3) emit light every sub frame period; and a voltage application section (7). The switching section (4) includes scan electrodes (8) disposed in a direction parallel to a direction in which the LED (3) is disposed, a plurality of signal electrodes (10) disposed in a direction at right angles to the scan electrodes, and liquid crystal elements (9) with changeable light extraction rates from the light guiding plate (2). The voltage application section (7) selects a scan electrode out of the plurality of scan electrodes every sub frame period and applies a voltage thereto, and applies, to at least one of the plurality of signal electrodes, a voltage in accordance with a light extraction rate of the liquid crystal element (9). The present invention can be suitably used as a backlight of an image display device.

### TECHNICAL FIELD

The present invention relates to a dimming device and an image display device including the dimming device.

### BACKGROUND ART

With display devices such as televisions, monitors, portable phones, or the like, a backlight that emits light from the rear of a display panel is conventionally used for displaying an image. This backlight is roughly classified into, for example, a direct backlight or a sidelight backlight, based on different light emitting methods.

The direct backlight arranges a plurality of light sources in a matrix form, and emits light in a partial manner by controlling these light sources separately. FIG. 15 is a view illustrating a configuration of a conventional direct backlight. In a direct backlight 30 illustrated in (a) of FIG. 15, LED chips 31 serving as light sources are arranged in a matrix form. In this configuration, light is emitted from any area by separately controlling the ON and OFF of the LED chips 31. However, with this configuration, the LED chips 31 are disposed on the rear of the display panel, thereby resulting in having shadows of the LED chips 31 appear on the display panel. Hence, with the backlight 30, a sufficient distance between the LED chips 31 and a diffuser plate 32 as illustrated in (b) of FIG. 15 (shown by the arrow in (b) of FIG. 15) is necessarily ensured, and as a result the backlight 30 itself becomes thick in thickness, thereby preventing the reduction in thickness of the display device.

The sidelight backlight emits light by emitting light from a light source provided on a side surface of the light guiding plate to within the light guiding plate. FIG. 16 is a view illustrating a conventional sidelight backlight. In a sidelight backlight 40 illustrated in FIG. 16, light emitted from light sources 42 provided on side surfaces of the light guiding plate 41 is guided within the light guiding plate 41, and is totally reflected. Moreover, a light exiting plane side of the light guiding plate 41 is configured so as to intentionally break through this total reflection, whereby causing the light to exit outside. This configuration although allows for reducing the thickness than that of the direct backlight, it is not easy to achieve the configuration which allows the breaking through of the total reflection of light, and it is difficult to control the output of the light. Hence, with this configuration, it is difficult to emit light in a partial manner from any area.

On the other hand, until now, techniques using liquid crystal as a switching element has been considered for emitting light in a partial manner from any area with the sidelight backlight, for example as disclosed in Patent Literature 1. FIG. 17 is a view illustrating a sidelight backlight including a liquid crystal element. A sidelight backlight 50 illustrated in FIG. 17 disposes a liquid crystal element 55 below a light guiding plate 51, which liquid crystal element 55 is sandwiched between two electrodes 52 and 54; (a) of FIG. 17 illustrates a voltage OFF state, and (b) of FIG. 17 illustrates a voltage ON state. The liquid crystal element 55 illustrated in FIG. 17 causes a white display when the voltage is in the OFF state; of light emitted from an LED 56, s-wave 57 is guided within the light guiding plate 51, and p-wave 58 is reflected on a lower part of the liquid crystal element 55 and is emitted outside from the light guiding plate 51. On the other hand, when the voltage is in the ON state, orientation of the liquid crystal changes, and both the s-wave 57 and the p-wave 58 are guided within the light guiding plate 51. As a result, no light is extracted outside the light guiding plate 51, thereby resulting as a black display. Techniques making use of the anisotropy of liquid crystal as such are also disclosed in Patent Literatures 2 through 5.

Moreover, Patent Literature 6 discloses a scanning backlight that controls lighting for each area. FIG. 18 is a view illustrating a configuration of such a scanning backlight. As illustrated in FIG. 18, in an illuminating device of Patent Literature 6, a backlight 116 disposed on a rear of a display panel includes a light guiding plate 114 made up of a plurality of blocks (114a to 114e). White, or R, G, B LEDs 111 are disposed on edges of the light guiding plate 114, and the LEDs are lit solely or as a set, which set includes a plurality of the LEDs 111. A lighted position is scanned by synchronizing with an image write-in position on the display panel. Thereafter, each of the pixel rows of the display panel are rewritten, and the LEDs 111 that are positioned in the pixel rows are lighted after a predetermined time has elapsed, to display an image. Techniques related to such scanning backlight are also disclosed in Patent Literatures 7 and 8.

Furthermore, Patent Literature 9 discloses a technique of a backlight formed of a plurality of lines, in which line modulation is carried out by changing its emission intensity in each line.

### CITATION LIST

### Patent Literature

Patent Literature 1

International Patent Application Publication No. WO2006/104159 A (Publication Date: Oct. 5, 2006)

Patent Literature 2

International Patent Application Publication No. WO2006/104160 A (Publication Date: Oct. 5, 2006)

Patent Literature 3

Japanese Patent Application Publication, Tokukaisho, No. 59-58421 A (Publication Date: Apr. 4, 1984)

Patent Literature 4

Japanese Patent Application Publication, Tokukai, No. 2000-171813 A (Publication Date: Jun. 23, 2000)

Patent Literature 5

Japanese Patent Application Publication, Tokukaisho, No. 63-116121 A (Publication Date: May 20, 1988)

Patent Literature 6

Japanese Patent Application Publication, Tokukai, No. 2001-210122 A (Publication Date: Aug. 3, 2001)

Patent Literature 7

Japanese Patent Application Publication, Tokukai, No. 2008-53614 A (Publication Date: Sep. 4, 2008)

Patent Literature 8

Japanese Patent Application Publication, Tokukai, No. 2009-69751 A (Publication Date: Apr. 2, 2009)

Patent Literature 9

Japanese Patent Application Publication, Tokukai, No. 2004-206044 A (Publication Date: Jul. 22, 2004)

### SUMMARY OF INVENTION

### Technical Problem

However, when liquid crystal is used as the switching element in the sidelight backlight, there are cases in which light is extracted even from areas other than those from which light is desirably emitted. Namely, when an electric current is flowed to a liquid crystal element to drive the liquid crystal element of any area, there are cases where crosstalk occurs, in which the electric current leaks to the surroundings of the liquid crystal element into which the electric current is to be flowed and causes the surroundings to also be driven.

For instance, when light is to be emitted from just two areas A and B as illustrated in (a) of FIG. 19, an aimed extracted amount of light is, for example 1,000 cd/m² in the areas A and B and 0 cd/m² in areas C and D that are positioned between these areas A and B (see (b) of FIG. 19). FIG. 19 is a view illustrating an aimed brightness distribution in a sidelight backlight that includes the liquid crystal element.

Light entered from the light source 61 into the light guiding plate 60 propagates from a left to right direction, as illustrated by the arrows in (a) of FIG. 19. The occurrence of crosstalk at this time may cause leakage of light guided inside the light guiding plate 60, into an area rear of the area A in a light traveling direction as illustrated in (a) of FIG. 20, i.e. into area C. FIG. 20 is a view illustrating an actual brightness distribution of the sidelight backlight including the liquid crystal elements. As such, if light leaks into the area C also, the image becomes displayed in a blurred state caused by the remaining light, thereby causing to have a low contrast.

Moreover, the light emitted from the light source 61 does not sufficiently reach the area B since the light has leaked into the area C. This causes a decrease in brightness in the area B. Illustrated in (b) of FIG. 20 is a graph of an actual extracted amount of light shown in (a) of FIG. 20. The arrow 62 in (b) of FIG. 20 shows the amount of extracted light in the area C in the state in which crosstalk is occurring, and the arrow 63 shows the amount of extracted light in the area B. As such, due to the occurrence of the crosstalk, the peak brightness in the area B decreases.

However, in Patent Literatures 1 through 5, no description is provided of how specifically the liquid crystal is driven, and the problem of crosstalk has not been mentioned. Hence, it is not possible to sufficiently hold down the crosstalk.

Moreover, the configurations of the scanning backlight in Patent Literatures 6 through 8 and the configuration of the backlight in Patent Literature 9 are not capable of carrying out two dimensional area control, that is, not capable of controlling any area on a flat plane and not capable of partially extracting light.

The present invention is accomplished in view of the foregoing problems, and an object thereof is to provide a dimming device which emits light from any area on a flat plane, while holding down crosstalk.

### Solution to Problem

In order to attain the object, a dimming device according to the present invention includes:

a light guiding plate that guides light entered inside from its edge;

a light source disposed on the edge of the light guiding plate, the light source emitting light directed inside the light guiding plate;

light extraction means being disposed on a light exiting plane side of the light guiding plate, the light extraction means including (a) a plurality of strip-shaped scan electrodes disposed in parallel to each other in a direction parallel to a direction in which the light source is disposed, (b) a plurality of strip-shaped signal electrodes disposed in parallel to each other in a direction at right angles to the direction of the plurality of scan electrodes, and (c) elements formed on each of areas at which any of the scan electrodes intersect with any of the signal electrodes, the elements being changeable in its light extraction rate from the light guiding plate;

dividing means for dividing one frame period into a plurality of sub frame periods;

light source control means for controlling the light source, for every sub frame period, so that the light source is lighted for a time not more than that sub frame period, to emit the light from the light source; and

voltage application means for, for every sub frame period, selecting a scan electrode out of the plurality of scan electrodes and applying a voltage thereto, and applying, to at least one of the plurality of signal electrodes, a voltage in accordance with the light extraction rate of the element corresponding to the selected scan electrode and that at least one signal electrode.

Moreover, an image display device according to the present invention includes:

the dimming device of the present invention; and

a display panel disposed on a light exiting plane side of the dimming device.

According to the configuration, the dimming device of the present invention includes (i) a light guiding plate on which a light source is disposed on its edge, and (ii) light extraction means in which a plurality of scan electrodes and a plurality of signal electrodes are disposed in directions at right angles to each other, and in which elements whose light extraction is changeable is formed on every area where the scan electrodes intersect with the signal electrodes. Accordingly, it is possible to emit light from any area on the flat plane.

More specifically, the light extraction means is disposed on a light exiting plane side of the light guiding plate, the plurality of scan electrodes are arranged in parallel in a direction parallel to a direction in which the light source is disposed, and the plurality of signal electrodes are arranged in parallel in a direction at right angles to the plurality of scan electrodes. By applying a voltage to any one of the plurality of scan electrodes and by applying a voltage to any of the plurality of signal electrodes, it is possible to drive the element(s) formed on the area in which these electrodes intersect with each other. This allows for extracting light from the element(s).

Moreover, in the dimming device of the present invention, one frame period is subjected to time division into a plurality of sub frame periods, and for every sub frame period, control is carried out for application of a voltage to the scan electrodes and signal electrodes and for emission of light from the light source. More specifically, the light source control means controls the emission of light from the light source in any sub frame period, and the voltage application means selects a scan electrode in any sub frame period and applies a voltage to that scan electrode, and further selects at least one signal electrode out of the plurality of signal electrodes in the any sub frame period and applies a voltage to that at least one signal electrode.

One scan electrode out of a plurality of scan electrodes is selected in a certain sub frame period, so no change is made to the light extraction rate in the elements corresponding to other scan electrodes. Namely, a state in which no light is extracted is maintained. On the other hand, the elements corresponding to the selected scan electrodes are applied a voltage via respective signal electrodes that correspond to the elements, and as a result, the light extraction rate of the elements changes. Namely, just the plurality of elements aligned in one row along one scan electrode are controlled in the certain sub frame period.

At this time, by having, for every sub frame period, the light source be lighted just in that sub frame period, a flashlight having a duration time not more than the sub frame period is entered into the light guiding plate. This flashlight is emitted outside via just the plurality of (one row of) elements disposed along one scan electrode that is to be controlled. Therefore, the flashlight emitted in a certain sub frame period will not be emitted via another element in the same sub frame period, which another element is at a position away from the light source than the position of the element corresponding to the scan electrode to be controlled. This holds down the leakage of light in such a manner that the flashlight remains in the traveling direction of the flashlight, thereby preventing crosstalk.

Hence, it is possible to hold down the occurrence of light remaining caused by leakage of light, and allows for minimizing the occurrence of crosstalk.

Moreover, an image display device according to the present invention includes the dimming device of the present invention and a display panel disposed on a light exiting plane side of the dimming device. Namely, the image display device is an image display device that includes the dimming device of the present invention as a backlight. Hence, it is possible to accomplish a thin image display device that is reduced in thickness than a LED direct backlight and which allows for extracting light from any area on a flat plane, while holding down crosstalk.

### Advantageous Effects of Invention

The present invention includes a light guiding plate that guides light entered inside from its edge; a light source disposed on the edge of the light guiding plate, the light source emitting light directed inside the light guiding plate; light extraction means being disposed on a light exiting plane side of the light guiding plate, the light extraction means including (a) a plurality of strip-shaped scan electrodes disposed in parallel to each other in a direction parallel to a direction in which the light source is disposed, (b) a plurality of strip-shaped signal electrodes disposed in parallel to each other in a direction at right angles to the direction of the plurality of scan electrodes, and (c) elements formed on each of areas at which any of the scan electrodes intersect with any of the signal electrodes, the elements being changeable in its light extraction rate from the light guiding plate; dividing means for dividing one frame period into a plurality of sub frame periods; light source control means for controlling the light source, for every sub frame period, so that the light source is lighted for a time not more than that sub frame period, to emit the light from the light source; and voltage application means for, for every sub frame period, selecting a scan electrode out of the plurality of scan electrodes and applying a voltage thereto, and applying, to at least one of the plurality of signal electrodes, a voltage in accordance with the light extraction rate of the element corresponding to the selected scan electrode and that at least one signal electrode. Hence, it is possible to provide a dimming device that is capable of emitting light from any area on a flat plane, and which holds down the crosstalk.

### BRIEF DESCRIPTION OF DRAWINGS

FIG. 1

FIG. 1 is a block diagram illustrating a configuration of a dimming device according to First Embodiment.

FIG. 2

FIG. 2 is a top view illustrating a configuration of a dimming device according to First Embodiment.

FIG. 3

FIG. 3 is a cross sectional view illustrating a configuration of a dimming device according to First Embodiment.

FIG. 4

FIG. 4 is a cross sectional view illustrating a further configuration of a dimming device according to First Embodiment.

FIG. 5

FIG. 5 is a view illustrating a pattern of a voltage applied to a signal electrode.

FIG. 6

FIG. 6 is a cross sectional view illustrating a configuration of an image display device including a dimming device according to First Embodiment.

FIG. 7

FIG. 7 is a view illustrating a display example of an image on a display panel of the image display device illustrated in FIG. 6.

FIG. 8

FIG. 8 is a top view illustrating a configuration of a dimming device according to Second Embodiment.

FIG. 9

FIG. 9 is a cross sectional view illustrating a configuration of a dimming device according to Second Embodiment.

FIG. 10

FIG. 10 is a view illustrating a light extraction area set in advance for every one frame period in the dimming device illustrated in FIG. 2, and an extracted amount of light.

FIG. 11

FIG. 11 is a view illustrating a driving pattern illustrated in Example 1.

FIG. 12

FIG. 12 is a view illustrating a light extraction rate in each of the light extraction areas.

FIG. 13

FIG. 13 is a view illustrating how light is extracted in the light extraction areas.

FIG. 14

FIG. 14 is a view illustrating how light is extracted in the light extraction areas.

FIG. 15

FIG. 15 is a view illustrating a configuration of a conventional direct backlight.

FIG. 16

FIG. 16 is a view illustrating a configuration of a conventional sidelight backlight.

FIG. 17

FIG. 17 is a view illustrating a sidelight backlight that includes a liquid crystal element.

FIG. 18

FIG. 18 is a view illustrating a configuration of a conventional scanning backlight.

FIG. 19

FIG. 19 is a view illustrating a target brightness distribution for a sidelight backlight including liquid crystal elements.

FIG. 20

FIG. 20 is a view illustrating an actual brightness distribution of a sidelight backlight including the liquid crystal elements.

### DESCRIPTION OF EMBODIMENTS

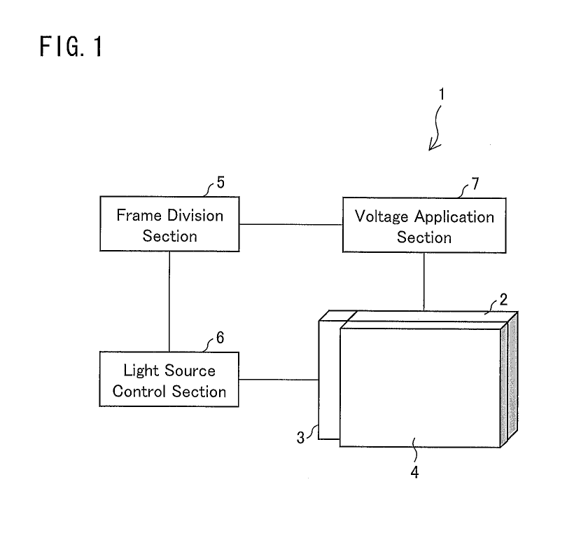

Described in detail below is an embodiment of the present invention, with reference to FIGS. 1 through 10. The following embodiment exemplifies an example that uses liquid crystal as an element having a changeable light extraction rate, however the present invention is not limited to this, and various known elements may be used.

### First Embodiment

(Configuration of Dimming Device 1)

FIG. 1 is a block diagram illustrating a configuration of a dimming device 1 according to the present embodiment.

As illustrated in FIG. 1, the dimming device 1 includes a light guiding plate 2, an LED (light source) 3, a switching section (light extraction means) 4, a frame division section (dividing means) 5, a light source control section (light source control means) 6, and a voltage application section (voltage application means) 7.

The dimming device 1 is a sidelight type dimming device capable of controlling, per area, light extraction that propagates within the light guiding plate 2.

More specifically, the LED 3 is disposed on an edge of the light guiding plate 2, and light emitted from the LED 3 is entered from the edge to inside the light guiding plate 2. Moreover, a switching section 4 is disposed on a light exiting plane side of the light guiding plate 2. The light exiting plane side of the light guiding plate 2 in the present specification simply denotes a plane on a side from which light is extracted by the switching section 4, and does not mean a plane from which light is emitted by the light guiding plate 2 by itself.

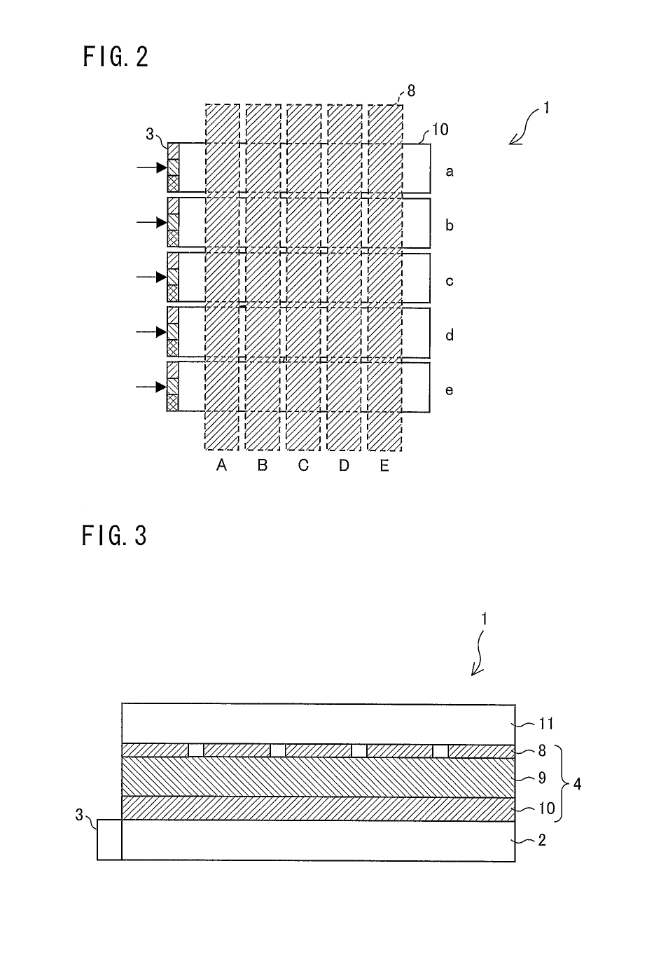

As illustrated in FIG. 2, the switching section 4 has a plurality of strip shaped scan electrodes 8 disposed in parallel in a direction parallel to the direction in which the LED 3 are disposed (column direction in FIG. 2), and has a plurality of signal electrodes 10 disposed in a direction at right angles to the plurality of scan electrodes 8 (row direction in FIG. 2). FIG. 2 is a view illustrating dispositions of the scan electrodes 8 and the signal electrodes 10. The dimming device 1, by applying a voltage to any one of the plurality of the scan electrodes 8 and applying a voltage to any one of the plurality of the signal electrodes 10, can extract light from an area at which that scan electrode 8 and that signal electrode 10 intersect with each other.

That is to say, on the area in which the scan electrode 8 and the signal electrode 10 intersect with each other, a liquid crystal element (element) 9 whose light extraction rate is changeable is formed, as illustrated in FIG. 3. FIG. 3 is a cross sectional view illustrating a configuration of the switching section 4. Hence, by selectively applying a voltage to the scan electrode 8 and the signal electrode 10, it is possible to control the light extraction rate of the liquid crystal element 9 formed at the intersection of these electrodes, thereby enabling extraction of light from any area on the flat plane.

Moreover, the dimming device 1 carries out time division of one frame period into a plurality of sub frame periods, and controls, for every sub frame period, application of a voltage to the scan electrodes 8 and the signal electrodes 10 and emission of light from the LED 3. More specifically, the light source control section 6 controls the emission of light from the LED 3 in any sub frame period, and the voltage application section 7 selects any one scan electrode 8 to apply a voltage in any sub frame period, and further selects at least one of the plurality of signal electrodes 10 in the any sub frame period, to apply a voltage to that selected signal electrode(s) 10.

In a sub frame period, any one of the plurality of scan electrodes 8 is selected, so therefore the light extraction rates of the liquid crystal elements 9 corresponding to any other scan electrodes 8 do not change. Namely, a state in which completely no light is extracted is maintained. On the other hand, the liquid crystal elements 9 that correspond to the selected scan electrode 8 are applied a voltage through a respective one of the signal electrodes 10, for every liquid crystal element 9, and as a result, the light extraction rates of the liquid crystal elements 9 change. That is to say, just the plurality of liquid crystal elements 9 that are aligned in one row along the one scan electrode 8 is controlled in the sub frame period.

At this time, a flashlight having a duration of not more than a sub frame period is entered into the light guiding plate 2 by lighting the LED 3 every sub frame period within that sub frame period, i.e. for a time not more than the sub frame period. Namely, in the dimming device 1, the LED 3 is continuously lighted for a time not more than the sub frame period. This flashlight is emitted externally just via a plurality of (one row of) liquid crystal elements 9 disposed along one scan electrode 8 that is to be controlled. Accordingly, the flashlight emitted during a certain sub frame period is not emitted via another liquid crystal element 9 at a position more away from the LED 3 as compared to the liquid crystal element 9 corresponding to the scan electrode 8 to be controlled, in the same sub frame period. This prevents leakage of light in such a manner that the light remains in the traveling direction of the flashlight, thereby preventing crosstalk.

As a result, it is possible to hold down the occurrence of light remaining caused by leakage of the light, and prevent the occurrence of crosstalk. Details of light extraction control in the dimming device 1 are described later.

The light guiding plate 2 guides light that is entered into the light guiding plate 2 from the LED 3, within the light guiding plate 2. The light guiding plate 2 may be of any shape as long as a plurality of scan electrodes 8 and signal electrodes 10 can be provided in parallel in the row and column directions, and is set as appropriate in accordance with the shape of the dimming device 1. The light guiding plate 2 may be made of material such as an acrylic board, polyurethane resin, polycarbonate resin, PMMA (Polymethyl methacrylate), PVA (Polyvinyl alcohol), or the like. Moreover, other than these, glass may also be used.

The LED 3 is a light source that emits light internally into the light guiding plate 2. The LED 3 may be disposed on any one edge of the light guiding plate 2, or may be disposed on each of two opposing edges of the light guiding plate 2. The number of LED 3 is not limited in particular, and for example a plurality of LED 3 may be disposed on the edge of the light guiding plate 2, or one LED 3 corresponding to a length of that edge of the light guiding plate 2 may be disposed. For example a white LED or a triple-colored LED of R, G, B may be used as the LED 3, however the light source of the dimming device 1 is not limited to this, and for example an inorganic EL element or an organic EL element may be used as the light source. These light emitting elements are surface emitting elements, and so therefore is advantageous in that it is possible to provide a light source corresponding to a size of a cross section of the strip shapes. As such, the light source of the dimming device 1 may be either of the surface emission or point emission.

Moreover, it is preferable that the LED 3 emits light that has a directivity traveling along a direction at right angles to the disposed direction of the LED 3. Namely, in the dimming device 1, the scan electrodes 8 are disposed parallel to the direction in which the LED 3 is disposed, and the signal electrodes 10 are disposed in a direction at right angles to the scan electrodes 8. Since the emission of light from the LED 3 is controlled every sub frame period, it is possible to collect the light to a target area by having the light emitted from the LED 3 travel forward along the direction at right angles to the direction in which the LED 3 is disposed, i.e., along a longer side direction of the signal electrodes 10.

The switching section 4 controls the amount of light extracted outside via the liquid crystal elements 9, by changing the light extraction rate. More specifically, by applying a voltage to any one of the plurality of scan electrodes 8 and applying a voltage to any one of the plurality of signal electrodes 10, the liquid crystal elements 9 formed on the area where these electrodes intersect are driven.

For example, a polymer dispersed liquid crystal may be used as the liquid crystal element 9. The polymer dispersed liquid crystal is made of material produced by uniformly dispersing liquid crystal material into polymer material; the liquid crystal switches between two states depending on whether or not a voltage is applied to the polymer dispersed liquid crystal: a light-scattering state and a transparent state. In the light-scattering state, orientation vector of the dispersed liquid crystal is directed to different directions, thereby causing light to scatter on the interface; this produces an opaque white-colored state. Namely, light is extracted. On the other hand, in the transparent state, the orientation vector of the liquid crystal is directed to a set direction, which makes refractive indices of the polymer material and the liquid crystal, each with respect to the light, become substantially equal, thereby making the light be in a non-scattered state and making the light pass through. In this case, no light is extracted.

Whether or not the liquid crystal is made into a scattering state or a transparent state while a voltage is applied or not applied can be designed in any way. Use of a polymer dispersed liquid crystal having such property does not require providing a polarizer or an alignment plate. This hence allows for achieving a light shutter with low electricity and with high light use efficiency.

For example, in a case in which the polymer dispersed liquid crystal is used as the liquid crystal material, the polymer dispersed liquid crystal may be, for example, PDLC (Polymer Dispersed Liquid Crystal), PNLC (Polymer Network-Liquid Crystal), or the like. PDLC is a liquid crystal in which droplets of liquid crystal are dispersed into a polymer cured from a uniform solution of liquid crystal molecules and polymerizable resin, and PNLC is of a configuration in which polymers cured from a uniform solution of liquid crystal molecules and polymerizable resin are formed in a liquid crystal layer so as to be in a three-dimensional network form, and the liquid crystal molecules are arranged irregularly therein.

On the other hand, in a reverse-type polymer dispersed liquid crystal which becomes in a transparent state when a voltage is applied, the polymer dispersed liquid crystal of the reverse mode (Anisotropic gel) is obtained by (i) mixing several % of polymerizable polymer into Nematic liquid crystal, (ii) injecting this Nematic liquid crystal into a liquid crystal cell which has been subjected to a rubbing process, and (iii) UV irradiating upon orientation. Moreover, the polymer dispersed liquid crystal of the reverse mode (UV curable liquid crystal/Nematic liquid crystal complex element) is obtained by mixing PDLC and PNLC, and UV irradiating after the orientation.

As the liquid crystal material, material having a greater birefringent ratio Δn than a component of the polymer material is sufficiently used. As the polymer material, for example acrylate material can be used.

Examples of the material of the scan electrode 8 and the signal electrodes 10 include, as to inorganic material, ITO (Indium Tin Oxide), IZO (transparent electrode material made of indium oxide and zinc oxide), and FTO (fluorine-doped tin oxide), and as to organic material, PEDOT-PSS (Poly(3,4-ethylenedioxythiophene) poly(styrenesulfonate)) and the like.

Moreover, the element used as the light shutter in the dimming device 1 is not limited to the above. For example, as with the conventional liquid crystal type, light can be transmitted and extracted by changing the orientation depending on whether or not the voltage is applied to make the liquid crystal be in the light transmitting state or the light shielded state, or the light may be extracted by use of an element produced by MEMS (Micro Electro Mechanical System).

The frame division section 5 divides one frame period into a plurality of sub frame periods. Namely, time of one frame period is divided and assigned to respective sub frame periods. For example, in a case in which one frame period is 60 milliseconds and is divided into five sub frame periods, one sub frame period is 12 milliseconds.

The frame division section 5 is not particularly limited as to the number into which one frame period is divided, however it is preferable that the one frame period is divided into the sub frame periods of a same number as the plurality of scan electrodes 8. As described above, the scan electrodes 8 are controlled every sub frame period, so by having the number of the sub frame periods agree with the number of the scan electrodes 8, the extraction of light can be easily controlled.

The light source control section 6 emits light from the LED 3 by controlling the LED 3 every sub frame period so that the LED 3 lights only during that sub frame period. Namely, in a case in which a plurality of light extraction areas are provided in the row direction of the light guiding plate 2 of the present embodiment, light is emitted from the LED 3 so that the LED 3 lights only during the sub frame period corresponding to that light extraction area.

The control by the light source control section 6 may include control of intensity of the light emitted from the LED 3 and of emission time of light from the LED 3.

The voltage application section 7 controls application of voltage to the scan electrodes 8 and the signal electrodes 10. Namely, the voltage application section 7 is to select any one of the plurality of scan electrodes 8 and apply a voltage thereto, and apply a voltage to at least one of the signal electrodes 10, every sub frame period. For example, the scan electrodes 8 can be controlled and applied a voltage successively from a scan electrode 8 positioned on the edge, and have the signal electrodes 10 be applied a voltage in line with this control and application of voltage to the scan electrodes 8.

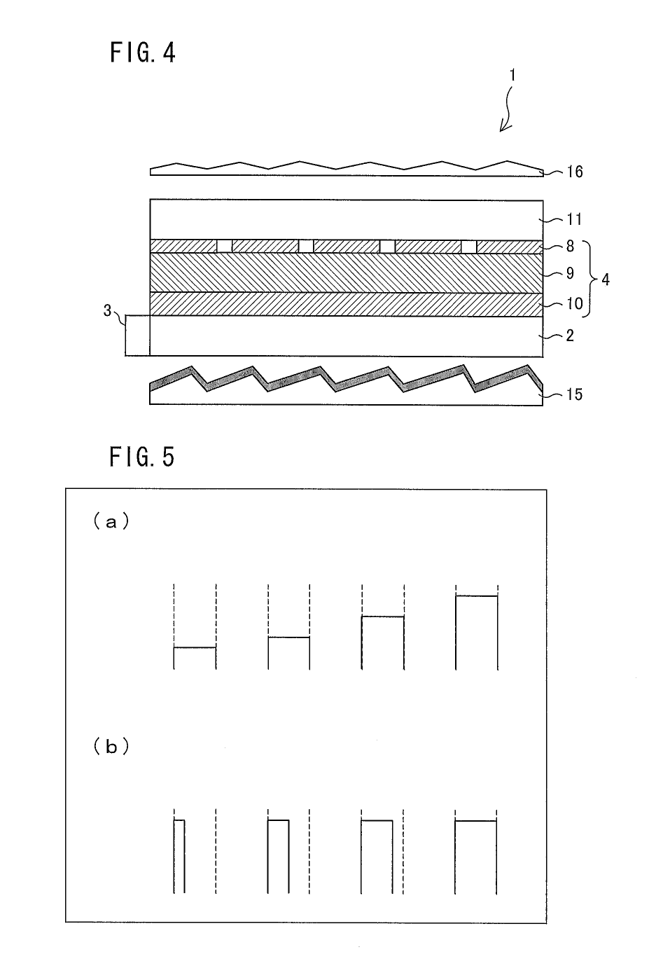

Moreover, the dimming device 1 according to the present embodiment may include, as illustrated in FIG. 4, a counter substrate 11 on the switching section 4, a scattering plate 15 on a plane of the light guiding plate 2 on an opposite side of the light exiting plane of the light guiding plate 2, and a reflective plate 16 upper of the counter substrate 11. FIG. 4 is a cross sectional view illustrating a further configuration of the dimming device 1.

By providing the scattering plate 15 on the plane of the light guiding plate 2 on the opposite side of the light exiting plane of the light guiding plate 2, it is possible to extract light in the downwards direction of the switching section 4, i.e. light scattered in a direction opposite of the light exiting plane side of the switching section 4, in the upper direction. Moreover, by providing the diffuser plate 16 on the light exiting plane side, it is possible to diffuse the light extracted from the switching section 4 with the diffuser plate 16, and emit the light to a broader range. Note that the material of the counter substrate 11 can be for example same material as the light guiding plate 2.

(Operation of Dimming Device 1)

Next described are operations of the dimming device 1 according to the present embodiment. In the embodiment, the dimming device 1 has the scan electrodes 8 and the signal electrodes 10 be disposed in a matrix form of 5×5 as illustrated in FIG. 2, and is intended so that a light extraction area is set in advance for every one frame period.

First, the frame division section 5 divides one frame period into a plurality of sub frame periods. It is preferable at this time to divide the one frame period into the number of sub frame periods same as the number of the plurality of scan electrodes 8. Namely, the scan electrodes 8 are controlled every sub frame period; by having the same number of sub frame periods as that of the scan electrodes 8, it is possible to easily control the extraction of light.

Next, the light source control section 6 causes light to be emitted from the LED 3 by controlling a timing that the LED 3 is lighted, every divided sub frame period. For example, in FIG. 2, when light is to be extracted from column B and column D of the scan electrodes 8 in row b of the signal electrodes 10, the LED 3 is lighted just in the sub frame periods corresponding to the columns B and D of the scan electrodes 8. Namely, in row b of the signal electrodes 10, the LED 3 are not lighted in the sub frame periods corresponding to columns A, C, and E of the scan electrodes 8. Hence, no light remains in an area in that sub frame period and an area subsequent in a light traveling direction adjacent to that area. Accordingly, even if the voltage is applied to surrounding areas of the subject to be light extracted, and the liquid crystal elements 9 formed in the surrounding areas become in a light extractable state, no light is extracted since no light is guided into the area corresponding to that liquid crystal element 9. This hence allows for holding down the crosstalk.

The voltage application section 7 selects any one scan electrode 8 out of the plurality of scan electrodes 8 and applies a voltage thereto, and applies, to any one of the plurality of signal electrodes 10, a voltage corresponding to a light extraction rate of the liquid crystal element 9 corresponding to the selected scan electrode 8 and signal electrode 10, every sub frame period. At this time, the selection of the scan electrode 8 to be applied a voltage may be carried out in such a manner that the scan electrodes 8 disposed in parallel are successively driven so that a voltage is applied sequentially one after another in one direction, for example. Moreover, the application of the voltage to the signal electrodes 10 is sufficiently carried out to the signal electrode 10 corresponding to the light extraction area, on the column of the selected scan electrode 8.

Moreover, in the light extraction control, when, for example, the light source control section 6 controls the LED 3 so that the LED 3 emit light of a fixed intensity every sub frame period, the amount of light extracted via the liquid crystal elements 9 may be controlled based on the value of the voltage to be applied to the signal electrodes 10 or by a time during which the voltage is applied to the signal electrodes 10.

Namely, when the light emitted from the LED 3 is of a fixed intensity, the voltage application section 7 can be controlled to apply to the signal electrodes 10 a voltage of an amplitude corresponding to the amount of light extracted via the liquid crystal element 9 corresponding to the scan electrode 8 and the signal electrode 10 selected in any one sub frame period. A pattern of the voltage applied to the signal electrodes 10 at this time is illustrated in (a) of FIG. 5. The width illustrated by the dotted lines in FIG. 5 indicates one sub frame period, and the height illustrated by the solid lines indicates the amplitude of the voltage.

Moreover, when the light emitted from the LED 3 is of a fixed intensity, the voltage application section 7 can be controlled so as to apply to the signal electrodes 10 a voltage of a fixed amplitude just for a time corresponding to the amount of light extracted via the liquid crystal element 9 that corresponds to the scan electrode 8 and the signal electrode 10 selected in any one sub frame period. The pattern of the voltage applied to the signal electrode 10 at this time is illustrated in (b) of FIG. 5. As such, when the intensity of the light emitted from the LED 3 is fixed, controlling the amplitude of the voltage to be applied to the signal electrode 10 or controlling the time during which the voltage is applied allows for emitting light of any brightness from any area on the flat plane.

On the other hand, when the light extraction rate from the switching section 4 is made fixed, the intensity of light or emitted time of the light from the LED 3 may be controlled.

For example, when the voltage application section 7 applies to just one out of the plurality of signal electrodes 10 a voltage that makes the light extraction rate in the liquid crystal element 9 corresponding to the selected scan electrode 8 and the signal electrode 10 be 100%, in any one sub frame period, the light source control section 6 can carry out control so that the LED 3 emits light of an intensity corresponding to the amount of light extracted via the liquid crystal element 9. Moreover, it is possible to control so that light is emitted from the LED 3 just for the time corresponding to the amount of light extracted.

This hence allows for irradiating light of any brightness from any area on the flat plane, and allows for extracting mostly all of entered flashlight via the liquid crystal element 9 to be selected. Accordingly, completely no flashlight reaches a position inside the light guiding plate 2 that is away from the LED 3 than the liquid crystal element 9. As a result, it is possible to further hold down the occurrence of crosstalk.

(Image Display Device)

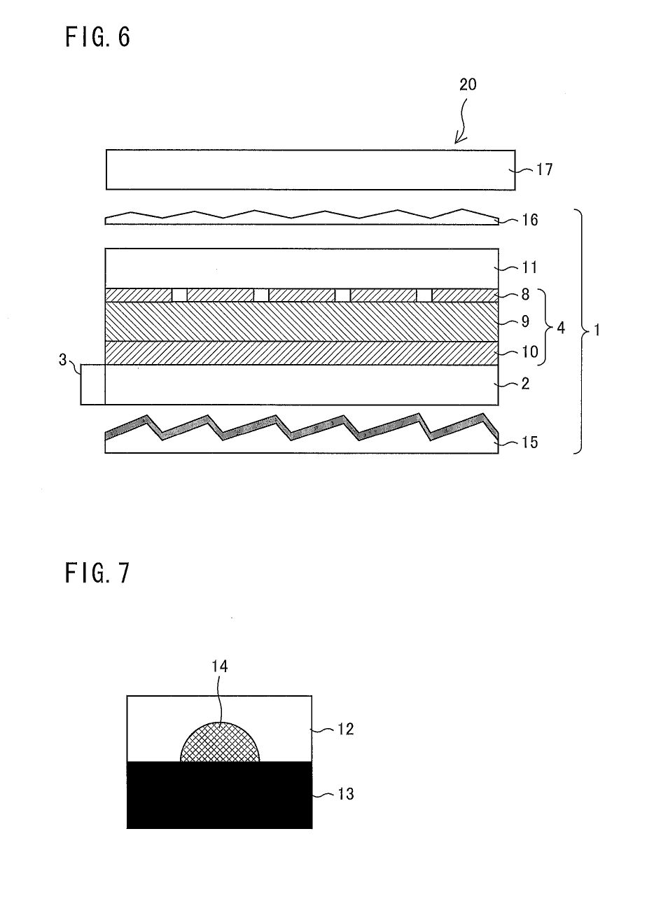

FIG. 6 is a cross sectional view illustrating a configuration of an image display device according to an embodiment of the present invention. As illustrated in FIG. 6, the dimming device 1 according to First Embodiment may serve as an image display device 20 by being combined with a display panel 17 that is disposed on a light exiting plane side of the dimming device 1 according to First Embodiment. Namely, the dimming device 1 may function as a backlight of the image display device 20. Hereinafter, the dimming device 1 is also expressed as backlight 1.

According to the configuration, for example when a scene of a setting sun or the like is displayed on the display panel 17 as illustrated in FIG. 7, an upper part 12 and the setting sun 13 of the screen is in a bright state, whereas a lower part 13 of the screen is in a dark state; for example, in a case in which the light emitted from the LED 3 travels in a row direction on the screen, the lower part 13 of the screen does not require lighting the backlight 1. FIG. 7 is a view illustrating a display example of the image on the display panel 17.

According to the backlight 1 of the present embodiment, it is possible to control the lighting and non-lighting of the LED 3 based on every area. Hence, it is possible to have no light be emitted from the LED 3 in the dark area of the lower part 13 of the screen. This causes no light leakage; as a result, it is possible to deepen sinking of the black, thereby allowing for improving contrast of the displayed image.

The display panel 17 is not limited in particular, and for example a liquid crystal display panel is suitably used. As such, by using the dimming device 1 with a liquid crystal display panel in combination, it is possible to have the dimming device 1 serve as a thin-type active backlight.

### Second Embodiment

Next described is Second Embodiment of the dimming device according to the present invention. In the dimming device 1 according to First Embodiment, the LED 3 is disposed on one edge of the light guiding plate 2; the present embodiment is only different in that the LED 3 is disposed on both edges of the light guiding plate 2. Hence, configurations identical to First Embodiment will be described with use of identical member numbers.

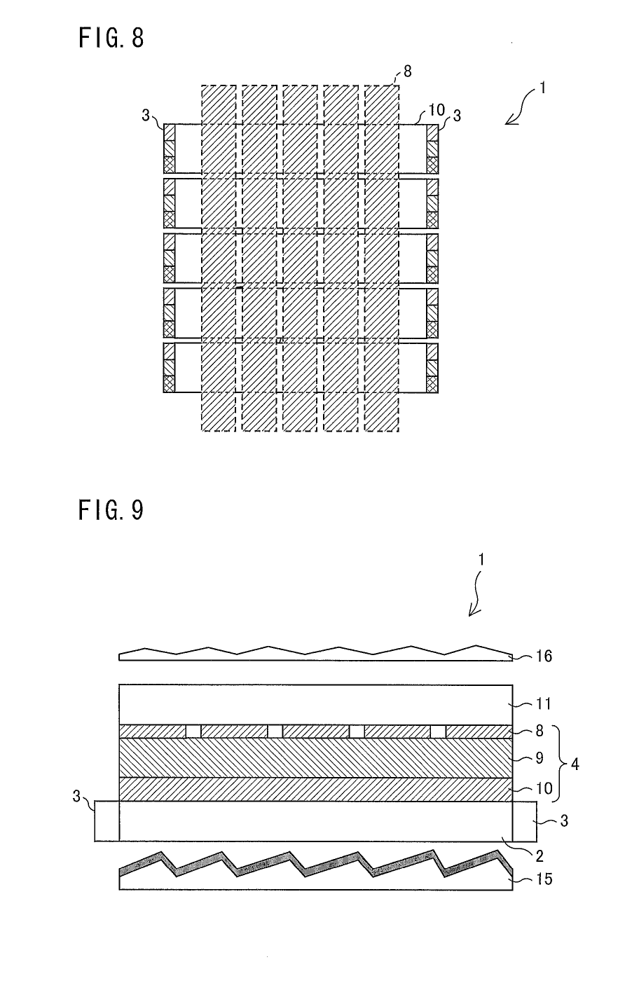

FIG. 8 is a top view illustrating a configuration of the dimming device 1 according to Second Embodiment, and FIG. 9 is a cross sectional view illustrating a configuration of the dimming device 1 according to Second Embodiment. As illustrated in FIGS. 8 and 9, the dimming device 1 according to the present embodiment has the LED 3 be disposed on either two edges of the light guiding plate 2, which edges face each other. Namely, with the dimming device 1 of the present embodiment, light enters the light guiding plate 2 from the LED 3 from two opposing directions.

For example, when light is to be extracted from column D or column E of the scan electrodes 8 in row b of the signal electrodes 10 illustrated in FIG. 2, if the emission of light from the LED 3 is carried out from the direction of column A of the scan electrodes 8, the light guided inside the light guiding plate 2 may leak in parts from column A to column C of the scan electrodes 8. In this case, brightness may decrease in the target column D or column E, or crosstalk may occur. This phenomenon increases in frequency as the size of the element for extracting light increases.

Accordingly, as illustrated in FIG. 8, providing the LED 3 also on an opposing edge allows for emitting light from the direction of the column E of the scan electrodes 8 (right side in FIG. 8), which makes it possible to control emitted light from the LED 3 in the vicinity of both edges of the light guiding plate 2. Hence, it is possible to have brighter light enter into the light guiding plate.

Moreover, it is preferable that the light source control section 6 controls the two LEDs 3 so that light is simultaneously emitted from the two LEDs 3. This allows for having light enter into the light guiding plate 2 simultaneously from two directions, thereby being able to further hold down the crosstalk.

Moreover, it is preferable that the light source control section 6 causes emission of light from just the LED 3 disposed closer to the scan electrode 8 to which the voltage is to be applied out of the LEDs 3 disposed on the two edges of the light guiding plate 2, in the sub frame period. For example, if just one LED 3 is always lighted, the temperature of the LED 3 may increase. In this case, the heat of the LED 3 may give effect on the property of the liquid crystal element 9, thereby making it difficult to control the light extraction rate. Accordingly, by changing, every sub frame period, the timing from which the light is emitted from the LEDs 3 provided on each of the opposing edges of the light guiding plate 2, it is possible to balance an increase in temperature of the LEDs 3 and maintain reliability of the device.

Furthermore, it is preferable that the light source control section 6 controls the two LEDs 3 so that light is emitted alternately from one of either the two LEDs 3, every one frame period or every sub frame period. This allows for holding down the temperature increase of the LEDs 3 and maintaining reliability of the device.

### Third Embodiment

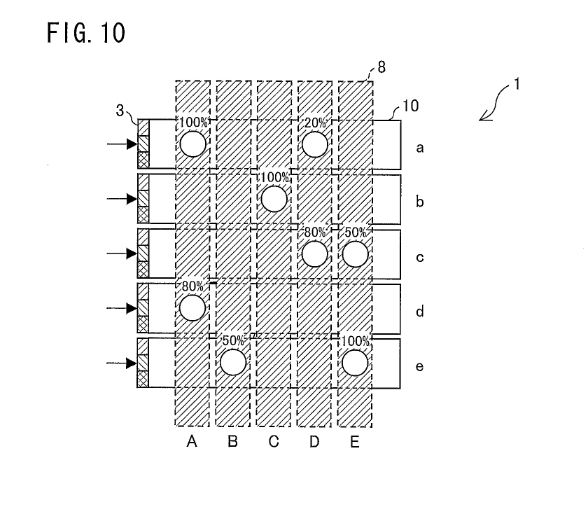

Next described is Third embodiment of the dimming device according to the present invention. The present embodiment differs from First Embodiment just in a method of controlling by the light source control section 6 and the voltage application section 7, each described in First Embodiment. Hence, configurations identical to those of First Embodiment are described with use of identical member numbers. FIG. 10 is a view depicting a light extraction area and an extracted amount of light set in advance for every one frame period in the dimming device 1.

For example, as illustrated in FIG. 10, in row e of the signal electrode 10, the amount of light extracted via the liquid crystal element 9 in column B of scan electrode 8 is 50%, and in column E, is 100%. As described above, the dimming device 1 is capable of reducing the crosstalk by applying a voltage to the scan electrode 8 and the signal electrode 10 and extracting light and controlling lighting of the LED 3, every sub frame period. However, in a case in which the voltage applied to the signal electrode 10 is changed according to the extracted amount of light, if the extracted amount of light is 50% as in column B, the light emitted from the LED 3 is not extracted completely from this area, so therefore there is a possibility that the crosstalk may occur.

In this case, the intensity of light emitted from the LED 3 in column B is to be varied depending on the extracted amount of light, and have the voltage be applied so that the light extraction rate in the liquid crystal element 9 is 100%, however in column E, the extracted amount of light is 50% in row c, and is 100% in row e. As such, when there is a signal electrode 10 with a different extracted amount of light on one scan electrode 8, control may be carried out as follows.

First, the frame division section 5 divides a sub frame period including an area having the different extracted amounts of light, into a plurality of sub-sub frame periods. The voltage application section 7 applies a voltage to the signal electrode 10 every sub-sub frame period, which voltage makes the light extraction rate in the liquid crystal element 9 be 100%. On the other hand, the light source control section 6 causes the LED 3 to emit light having an intensity corresponding to the extracted amount set in advance, every sub-sub frame period.

For example, a sub frame corresponding to column E of the scan electrodes 8 is divided into further two sub-sub frame periods, and a voltage is applied to the signal electrode 10 in the two sub-sub frame periods, which voltage makes the light extraction rate be 100%. At this time, the intensity of light emitted from the LED 3 in one of the two sub-sub frame periods is made to be 100%, and in the other one of the sub-sub frame periods, is made to be 200%. Namely, the time during which light having the intensity of 100% is emitted is made half of the sub frame period, so an actual amount of light extracted is 50%. Moreover, the time during which the light having the intensity of 200% is emitted is also half the sub frame period, so therefore an actual amount of light extracted is 100%. As such, by dividing one sub frame period into plural numbers, it is possible to have a light extraction rate in the liquid crystal element 9 as always 100%, even if the scan electrode 8 includes an area having a different extracted amount of light. This further allows for holding down the crosstalk.

Moreover, it is preferable that the dimming device according to the present invention is configured in such a manner that

the light source control means controls the light source so that the light of a single intensity is emitted from the light source every sub frame period, and

the voltage application means applies to each of the plurality of signal electrodes a voltage having an amplitude in accordance with an amount of light extracted via the element corresponding to the selected scan electrode and that signal electrode, continuously for a certain period of time, every sub frame period.

According to the configuration, the amount of light extracted via the element is controlled based on the value of the voltage applied to the signal electrode. Namely, the light source emits light of a fixed intensity every sub frame period, and a voltage to be applied to the signal electrode selected in the sub frame period is controlled so as to be an amplitude corresponding to an amount of light extracted via an element. This as a result makes it possible to emit light of any brightness from any area on the flat plane.

Moreover, it is preferable that the dimming device according to the present invention is configured in such a manner that

the light source control means controls the light source so that the light of a single intensity is emitted from the light source every sub frame period, and

the voltage application means applies to each of the plurality of signal electrodes a voltage having a fixed amplitude continuous for just a time in accordance with an amount of light extracted via the element corresponding to the selected scan electrode and that signal electrode, every sub frame period.

According to the configuration, the amount of light extracted via the element is controlled based on a time during which the voltage is applied to the signal electrode. Namely, the light source emits light of a fixed intensity every sub frame period, and a voltage of a fixed amplitude is applied to the signal electrode selected in the sub frame period. At this time, by applying a voltage to the signal electrode for a time in accordance with the amount of light extracted via the element, it is possible to emit light of any brightness from any area on the flat plane.

Moreover, it is preferable that the dimming device according to the present invention is configured in such a manner that

the voltage application means applies to just one of the plurality of signal electrodes in any one of the sub frame periods, a voltage that makes the light extraction rate of the element corresponding to the selected scan electrode and that signal electrode be 100%, and

the light source control means controls the light source so that light having an intensity in accordance with an amount of light extracted via the element that corresponds to the scan electrode and signal electrode to which the voltage is applied in the any one of the sub frame periods, is emitted from the light source, just in the any one of the sub frame periods.

According to the configuration, the amount of light extracted via the element is controlled depending on the intensity of light emitted from the light source. Namely, with the signal electrode selected in any sub frame period, a voltage is applied which causes the light extraction rate in the element to be 100%, and the intensity of light emitted from the light source in the sub frame period is controlled depending on the amount of light extracted via the element. This causes a substantially complete extraction of the flashlight entered, via the element to be selected; as a result, totally no flashlight reaches a position inside the light guiding plate that is away from the light source than the element. Hence, it is possible to further hold down the generation of the crosstalk.

Moreover, it is preferable that the dimming device according to the present invention is configured in such a manner that

the dividing means divides the any one of the sub frame periods into a plurality of sub-sub frame periods,

the voltage application means applies to just one of the plurality of signal electrodes a voltage that makes the light extraction rate of the element corresponding to the selected scan electrode and that signal electrode be 100%, every sub-sub frame period, and

the light source control means controls the light source every sub-sub frame period so that light having an intensity in accordance with an amount of light extracted via the element that corresponds to the scan electrode and signal electrode to which the voltage is applied in that sub-sub frame period, is emitted from the light source just in that sub-sub frame period.

According to the configuration, when a voltage is applied to one of the plurality of scan electrodes in any sub frame period and a voltage is applied to at least two signal electrodes, it is possible to apply a voltage to any one of the plurality of signal electrodes by dividing the any sub frame period into a further plurality of sub-sub frame periods.

For example, when a voltage is applied to two or more signal electrodes, simultaneously with applying a voltage to any one of scan electrodes, the areas where these electrodes intersect becomes at least two; as a result, light is extracted simultaneously via a plurality of elements. At this time, even if the amount of light extracted via the plurality of elements in a single sub frame period are different, it is possible to control the extraction rate of the light for every element to be 100% by dividing the sub frame period into further sub-sub frame periods.

Namely, when light is extracted via a plurality of elements in any sub frame period, the sub frame period is divided into a plurality of sub-sub frame periods, and a voltage that makes the light extraction rate in the element corresponding to the signal electrode and the selected scan electrode be 100% is applied to one of the signal electrodes, for every sub-sub frame period. That is to say, in the present configuration, the voltage applied to the signal electrode is controlled so that the light extraction rate in the element is always 100%.

On the other hand, in the sub-sub frame period, the light source emits light that has an intensity in accordance with the amount of light extracted via the element corresponding to the signal electrode and the scan electrode to which the voltage is applied. That is to say, the amount of light extracted via the element in the sub-sub frame period is controlled based on the intensity of the light emitted from the light source.

As such, even when light of different amounts are extracted from a plurality of elements in any sub frame period, it is possible to maintain the light extraction rate in the element as always 100% by further dividing the sub frame period. Since the light emitted from the light source is extracted by 100% via the element, it is possible to further hold down the crosstalk.

Moreover, it is preferable that the dimming device according to the present invention is configured in such a manner that

the dividing means divides the one frame period into the sub frame periods of a number same as that of the plurality of scan electrodes.

According to the configuration, the number of sub frame periods corresponds to that of the scan electrodes. As described above, the scan electrodes are controlled every sub frame period, so by having the number of sub frame periods agree with the number of the scan electrodes, it is possible to apply a driving method of the present invention to all the scan electrodes within one frame period. Hence, it is possible to hold down the occurrence of crosstalk in the entire light emitting plane.

Moreover, it is preferable that the dimming device according to the present invention is configured in such a manner that

the light source emits light having a directivity traveling along a direction at right angles to the direction in which the light source is disposed.

According to the configuration, the light emitted from the light source travels along a direction at right angles to a direction in which the light source is disposed. Namely, the scan electrodes are disposed in a direction parallel to the direction in which the light source is disposed, and the signal electrodes are disposed in a direction at right angles to the scan electrodes. Moreover, the scan electrodes and signal electrodes are controlled every sub frame period, and emission of light from the light source is also controlled every sub frame period. Hence, by having the light emitted from the light source travel in the direction at right angles to the direction in which the light source is disposed, i.e. travel along a longitudinal direction of the signal electrode, it is possible to collect the light on a target area.

Moreover, it is preferable that the dimming device according to the present invention is configured in such a manner that

the light source is disposed on each of two opposing edges of the light guiding plate.

According to the configuration, light can be entered from two opposing edges of the light guiding plate. As a result, brighter light can be entered into the light guiding plate.

Moreover, it is preferable that the dimming device according to the present invention is configured in such a manner that

the light source control means controls the two light sources so that the light is emitted simultaneously from the two light sources.

According to the configuration, light can be entered into the light guiding plate from two directions, simultaneously. This positively minimizes the generation of a shadow of the light. Hence, it is possible to further minimize the crosstalk.

Moreover, it is preferable that the dimming device according to the present invention is configured in such a manner that

the light source control means controls the two light sources every sub frame period, so that the light is emitted from a light source that is disposed closer to the scan electrode selected by the voltage application means in that sub frame period, out of the two light sources.

In a case in which light is entered from one edge of the light guiding plate, there are cases in which the light may slightly leak (be extracted) until the light reaches the target area, as the light separates away from the entered position. In this case, there are times in which not enough light that is equivalent to a target extracted amount remains for a target area. Accordingly, as in the foregoing configuration, light is emitted from just the light source that is disposed closer to the scan electrode to which the voltage is applied in the sub frame period, out of the light sources disposed on the two edges of the light guiding plate. This allows for the light equivalent of the target extracted amount to reach the target area.

Moreover, it is preferable that the dimming device according to the present invention is configured in such a manner that

the light source control means controls the two light sources so that the light is emitted alternately from one of the two light sources, every one frame period.

Moreover, it is preferable that the dimming device according to the present invention is configured in such a manner that

the light source control means controls the two light sources so that the light is emitted alternately from one of the light sources, every sub frame period.

According to the configuration, light is emitted from one of the light sources disposed on either two edges of the light guiding plate, alternately every one frame period or every sub frame period. For example, if only one light source is always lighted, that light source may increase in temperature. In this case, the heat of the light source may give effect on the property of the element, thereby making it difficult to control the light extraction rate. Hence, by alternately switching over the timing that light is emitted from the light sources provided on either opposing edges of the light guiding plate, for every frame period or every sub frame period, it is possible to minimize the increase in temperature of the light source and maintain reliability of the device.

### Examples

Described below are Examples of the present invention. The present invention is not limited to these Examples.

### Example 1

The present example prepared a 30 cm×40 cm, 5×5matrix control dimming device of a configuration illustrated in FIG. 10, by a method described below.

(Light Guiding Plate)

As the light guiding plate, an acrylic plate having a width of 450 cm and a height of 4 mm was used. On this acrylic plate, five strips of ITO (indium tin oxide) each of a width of 8 cm were pattern formed at intervals of 0.1 mm, to serve as electrodes.

Moreover, as the counter substrate, an acrylic plate having a width of 450 cm and a height of 4 mm was used, and ITO of a width 6 cm was patterned thereon in a direction at right angles to the electrodes formed on the light guiding plate, to form electrodes.

(Switching Element)

Polymer dispersed liquid crystal was used as the switching element (element).

The polymer dispersed liquid crystal was made up of (i) liquid crystal material whose orientation changes depending on electric field and (ii) polymer material mixed so as to surround the liquid crystal material. This polymer dispersed liquid crystal switches between a transparent state and a scattered state by matching of refractive index on an interface between the liquid crystal material and the polymer material. The matching of the refractive index was controlled based on the orientation of the liquid crystal molecules effected by an electric field. In the present Example, the polymer dispersed liquid crystal was designed to be in the transparent state when no electric field is applied and to be in the scattered state when electric field is applied, and so that the refractive index of the polymer material is substantially the same as the refractive index of the light guiding plate. Namely, in the present example, control was carried out with use of a reverse type polymer dispersed liquid crystal described in the embodiment described above, to extract the light in the scattered state while the voltage is applied.

Such a liquid crystal was disposed between the foregoing acrylic plates, i.e. the light guiding plate and the counter substrate, so as to have a film thickness of 10 μm. This obtained a switching element using the polymer dispersed liquid crystal.

(Disposition of LED)

In the present example, white LED chips having a height of 3.5 mm, a width of 7 mm, and a depth of 1.5 mm were used as the light source. These white LED chips were mounted on one end of the light guiding plate, and were disposed evenly at intervals of 5 mm on one light guiding plate. Note that a rated voltage was 18 V, and a rated current was 100 mA.

(Configuration of Dimming Device)

Light was entered from the LED into the light guiding plate obtained in the method described above. While a voltage was applied, the light entered into the polymer dispersed liquid crystal became scattered and guided wave conditions were disturbed, thereby causing external extraction of light. At this time, the light extracted amount saturated by applying a voltage of 60 V; until this saturated voltage was reached however, it was possible to control the extracted amount of light based on the strength of the voltage.

Moreover, a diffuser plate was disposed on an upper side of the light guiding plate, i.e. the light extracting plane side of the light guiding plate, and a scattering plate was disposed on a lower side of the light guiding plate, i.e. on a plane on the opposite side of the light extracting plane. This made it possible to extract the light scattered in the downward direction by the switching element, again from the upper side. Moreover, by disposing the scattering plate on the upper side of the light guiding plate, it became possible to broaden a light extracting direction on the light extracting plane side. This prepared the dimming device of the present example.

(Drive Method)

The dimming device obtained by the above was driven as described below. In the present example, circled areas in FIG. 10 were lighted in the dimming device, out of the 5×5 matrix disposition. Namely, in column A, the extracted amount of light in row a was made to be 100% and the extracted amount of light in row d was made to be 80%; in column B, the extracted amount of light in row e was made to be 50%; in column C, the extracted amount of light in row b was made to be 100%; in column D, the extracted amount of light in row a was made to be 20% and the extracted amount of light in row c was made to be 80%; and in column E, the extracted amount of light in row c was made to be 50% and the extracted amount of light in row e was made to be 100%. As such, in Example 1, all columns A through E include an area that is lighted, so the emission of light from the LED within one frame was flash lighted by dividing the emission of light by five.

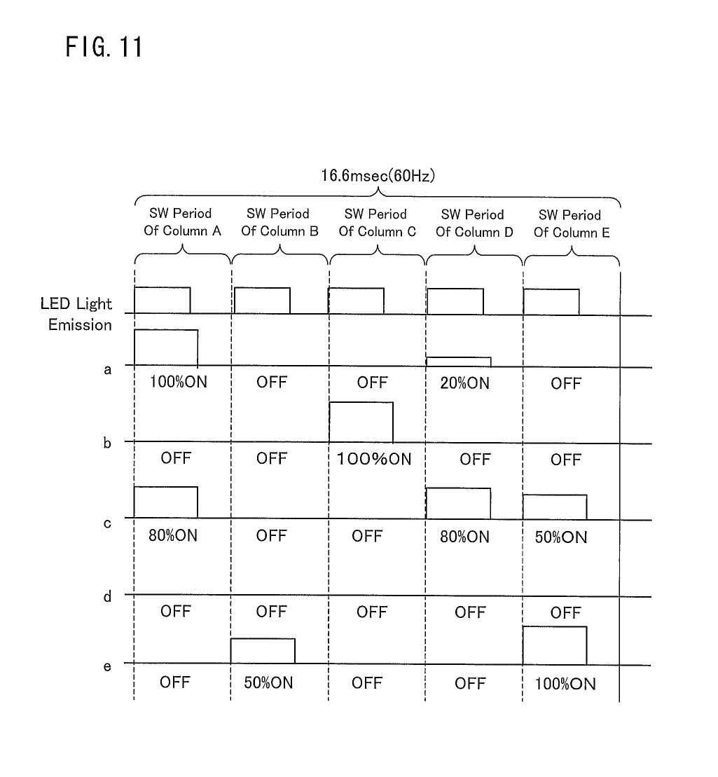

First, so as to drive the switching element from columns A to E in 60 Hz for one frame, the one frame was divided into 3.7 milliseconds (one fifth of 60 Hz) per one column, i.e. into five sub frame periods (also called switching periods), to carry out flash lighting of the LED. At this time, a light emitting period was 2.5 milliseconds and a lights-out period was 1.2 milliseconds. These flash lighting periods were assigned to the switching periods (SW periods) of each of the column A through E as illustrated in FIG. 11. FIG. 11 is a view illustrating a driving pattern in Example 1. The flash lighting period was adjusted arbitrarily depending on a switching response time of the switching element or a light emitting brightness of the LED.

Next, in the switch timings of each of the assigned columns A through E, the ON/OFF state of the switching elements in rows a through e were controlled so as to match the light emitting timing in each of the columns.

(Switching Condition of Column A)

As described above, in the column A, the switching states of rows a and d were controlled so that the extracted amount of light in row a was 100% and the extracted amount of light in row d was 80%. More specifically, a pulse modulation method was employed, and a light extracted amount was controlled based on for how long the switching element is to be in the ON state during the LED light emitting period, in line with the light emitting period of the LED. The polymer dispersed liquid crystal used in the present example can be switched between 100% ON/OFF state in high speed, however since the response speed tends to become slow for the control in the intermediate state, it is preferable to employ the pulse modulation method. However, the present invention is not limited to this, and for example control may be carried out based on electric field strength, for example.

(Switching Condition for Column B)

In column B, the switching element was controlled and light was extracted as with column A, so that the extracted amount of light in row e was 50%.

(Switching Conditions for Columns C to E)

For columns C to E also, the switching element was controlled and light was extracted as with column A.

As such, by controlling the switching element and a light emitting state of the LED, the two-dimensional guide wave light extraction was controlled in the 5×5 matrix. As a result, in the present example, one frame is driven by 60 Hz, so with a human eye, the 5×5 matrix appeared to be emitting light by any brightness. Moreover, the light emitting state of just the columns in the switching element were controlled, so therefore it was difficult for the crosstalk to occur.

### Example 2

In the present example, the dimming device prepared in Example 1 was driven by a different method. More specifically, the lighting time of the LED was divided even further.

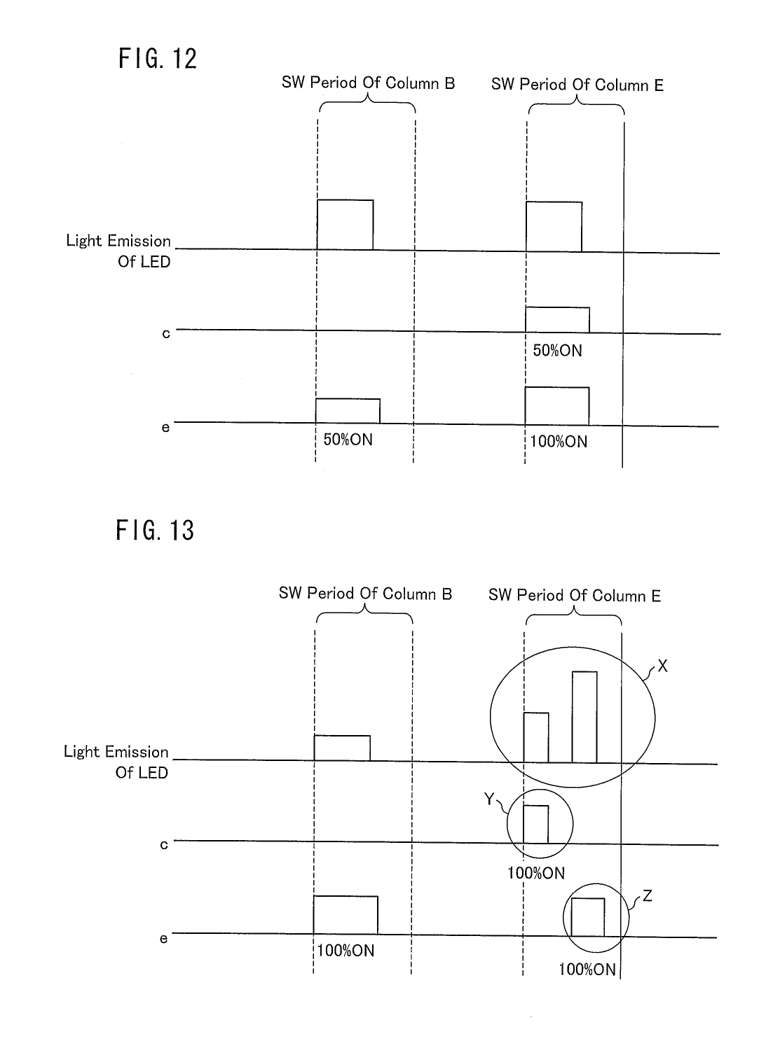

Example 1 described above controlled so that in row e, the extracted amount of light was made to be 50% in column B and 100% in column E. At this time, light was extracted in a switch selection period of each column, to reduce the crosstalk. However, as illustrated in FIG. 12, although in row e of column E, all light entered from the LED was extracted outside to achieve 100% light extraction, row c of column E only extracted 50% of light, whereby having a possibility that a part of the light not extracted causes the crosstalk. FIG. 12 is a view illustrating a light extraction rate of the light extraction areas.

Accordingly, in the present example, when there are a plurality of extraction areas in each column and an extraction rate of each of the areas differ from each other, control was carried out by further dividing the light emitting period of the LED, as described below.

(When Column B is Selected)

In order to have just row e to emit light, in column B, during a period in which the LED was lighted, the light emitting amount of the LED was made to be 50% to make the light extraction rate of the switching element be 100%, as illustrated in FIG. 12. FIG. 12 is a view illustrating a light extraction rate in each of the light extraction areas. Here, the light extraction rate of the switching element is made to be 100%, which causes no light to remain in the direction that the light is guided. This allowed for preventing the crosstalk.

(When Column E is Selected)

In column E, light was extracted from row c and row e. More specifically, as illustrated in FIG. 13, the light emitting period when column E of the LED was selected was further divided into two; the first half thereof (shown as “Y” in FIG. 13) received light from the LED to cause emission of light in row c, and the second half (shown as “Z” in FIG. 13) received light from the LED to cause emission of light in row e. FIG. 13 is a view illustrating how light is extracted in each of the light extraction areas. In this case, since row c has a target extracted amount of light of 50%, the light intensity of the LED was made to be 100%, and the light extraction rate of the switching element in row c was made to be 100%. Namely, the time during which light having an intensity of 100% was emitted becomes half the sub frame period; as a result, the substantial amount of light extracted was 50%. The light emitting strength of the LED is shown as “X” in FIG. 13.

Next, since the target extracted amount of light in row e was 100%, the light intensity of the LED was made twice of when light was emitted in row c, i.e. 200%, to achieve the light extraction rate of the switching element of 100%. The time during which the light having the intensity of 200% was emitted was also made half the sub frame period, so the substantial amount of light extracted was 100%.

As such, since the light extraction ratio of the switching element was always 100%, no crosstalk occurred.

### Example 3

Example 3 changes the driving method in Example 2. More specifically, Example 2 controlled the extracted amount of light by changing the intensity of the light emitted from the LED, whereas in Example 3, the intensity of the light emitted from the LED is the same, and a period that the switching element was in an ON state was changed.

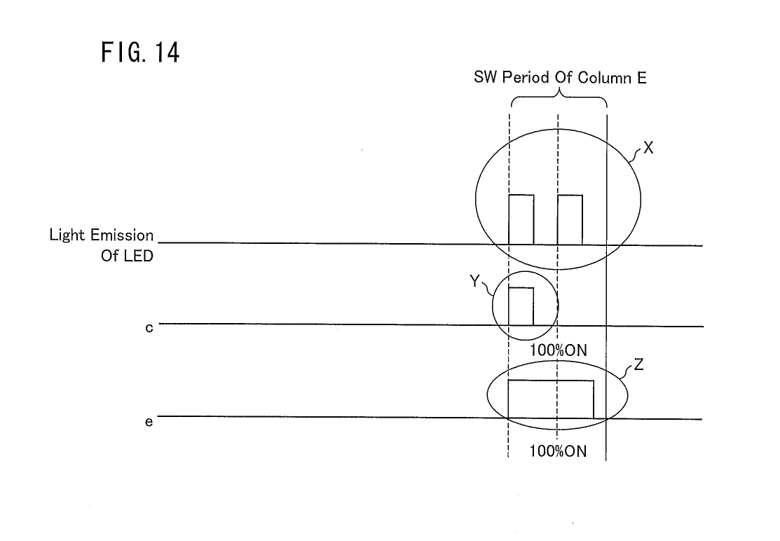

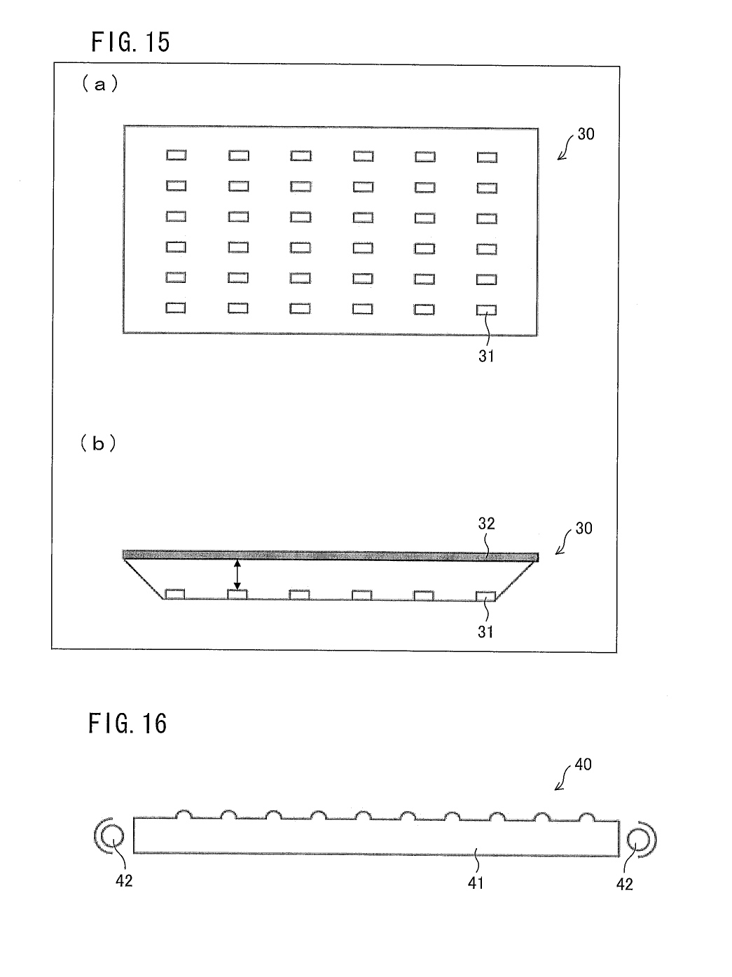

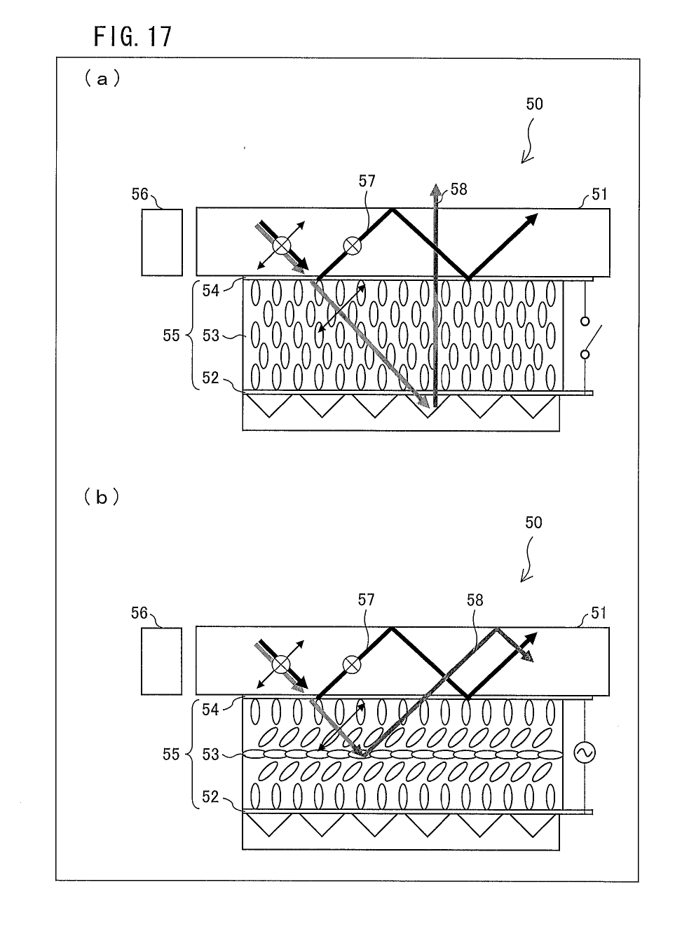

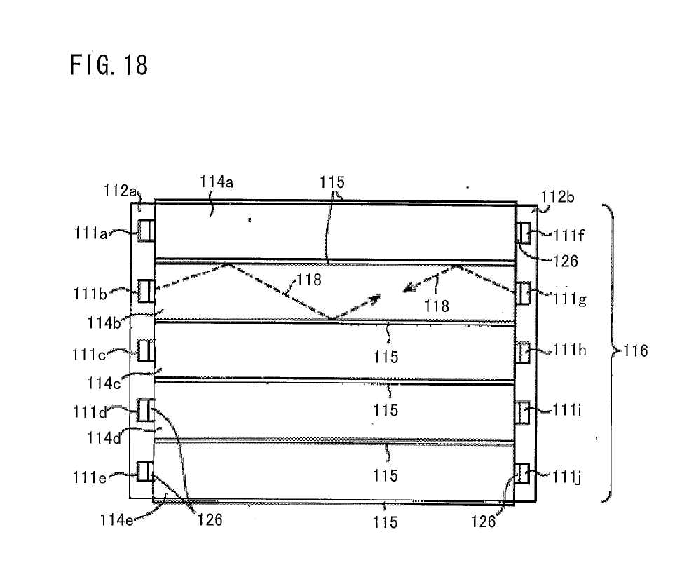

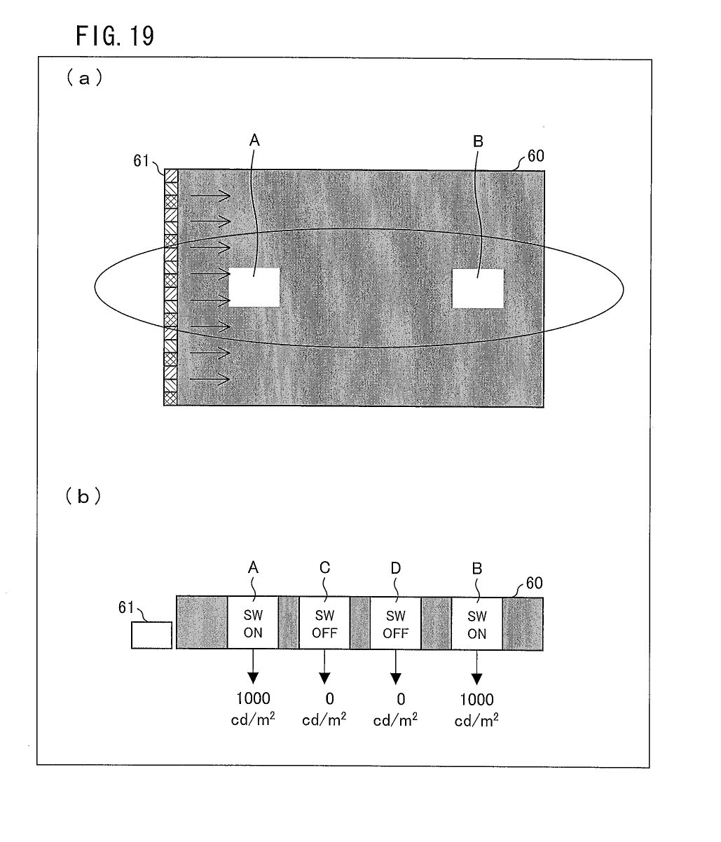

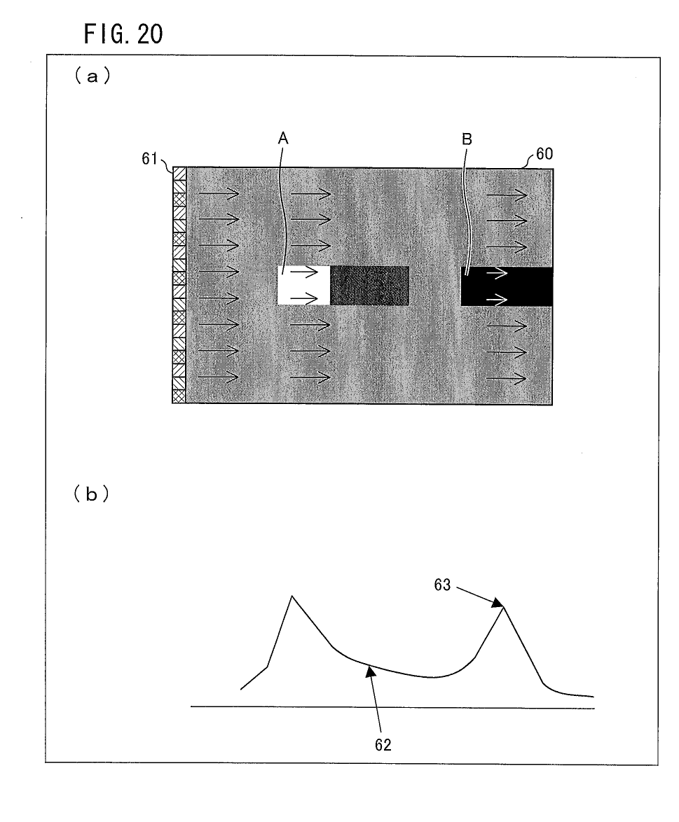

Namely, as illustrated in FIG. 14, in row c in the selected period of column E in which the extracted amount of light was 50%, Example 3 extracted light having an intensity of 100% with a light extraction rate of the switching element being 100% in just the first half (shown by “Y” in FIG. 14) of the divided halves. Namely, the time during which light having the intensity of 100% was emitted was half the sub frame period, so therefore the substantially extracted amount of light was 50%.

Moreover, in row e, light having the intensity of 100% was extracted continuously with the light extraction rate of the switching element being 100%, during both divided halves (shown by “Z” in FIG. 14). FIG. 14 is a view illustrating a light extracting method in the light extraction areas, and a light emitting intensity from the LED is indicated by “X” in FIG. 14. In this case also, transmissivity of the switching element was always 100%, so no crosstalk occurred.

An image display device was produced with use of the dimming device prepared in the present example as a backlight. More specifically, the dimming device of the present example was disposed on a lower part of a multi-purpose 20-inch TFT liquid crystal display panel, to drive the dimming device in sync with the driving of the liquid crystal display panel. At this time, the light emitting pattern of the dimming device was adjusted so as to match the image displayed on the liquid crystal display panel. As a result, it was possible to carry out image display that has a high contrast.

A general LED direct active backlight has a thickness of approximately 3 cm, whereas the dimming device of the present example has a thickness of not more than 5 mm. As a result, it was possible to make a thin image display device.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention may be suitably used as a backlight of a display device such as a television, a personal computer, a portable phone, or a portable information terminal.

### REFERENCE SIGNS LIST

1 dimming device
2 light guiding plate
3 LED (light source)
4 switching section (light extraction means)
5 frame division section (dividing means)
6 light source control section (light source control means)
7 voltage application section (voltage application means)
8 scan electrode
9 liquid crystal element (element)
10 signal electrode

1. A dimming device, comprising:
a light guiding plate that guides light entered inside from its edge;
a light source disposed on the edge of the light guiding plate, the light source emitting light directed inside the light guiding plate;
light extraction means being disposed on a light exiting plane side of the light guiding plate, the light extraction means including (a) a plurality of strip-shaped scan electrodes disposed in parallel to each other in a direction parallel to a direction in which the light source is disposed, (b) a plurality of strip-shaped signal electrodes disposed in parallel to each other in a direction at right angles to the direction of the plurality of scan electrodes, and (c) elements formed on each of areas at which any of the scan electrodes intersect with any of the signal electrodes, the elements being changeable in its light extraction rate from the light guiding plate;
dividing means for dividing one frame period into a plurality of sub frame periods;
light source control means for controlling the light source, for every sub frame period, so that the light source is lighted for a time not more than that sub frame period, to emit the light from the light source; and
voltage application means for, for every sub frame period, selecting a scan electrode out of the plurality of scan electrodes and applying a voltage thereto, and applying, to at least one of the plurality of signal electrodes, a voltage in accordance with the light extraction rate of the element corresponding to the selected scan electrode and that at least one signal electrode.

2. The dimming device according to claim 1, wherein
the light source control means controls the light source so that the light of a single intensity is emitted from the light source every sub frame period, and
the voltage application means applies to each of the plurality of signal electrodes a voltage having an amplitude in accordance with an amount of light extracted via the element corresponding to the selected scan electrode and that signal electrode, continuously for a certain period of time, every sub frame period.

3. The dimming device according to claim 1, wherein
the light source control means controls the light source so that the light of a single intensity is emitted from the light source every sub frame period, and
the voltage application means applies to each of the plurality of signal electrodes a voltage having a fixed amplitude continuous for just a time in accordance with an amount of light extracted via the element corresponding to the selected scan electrode and that signal electrode, every sub frame period.

4. The dimming device according to claim 1, wherein
the voltage application means applies to just one of the plurality of signal electrodes in any one of the sub frame periods, a voltage that makes the light extraction rate of the element corresponding to the selected scan electrode and that signal electrode be 100%, and
the light source control means controls the light source so that light having an intensity in accordance with an amount of light extracted via the element that corresponds to the scan electrode and signal electrode to which the voltage is applied in the any one of the sub frame periods, is emitted from the light source, just in the any one of the sub frame periods.

5. The dimming device according to claim 1, wherein
the dividing means divides the any one of the sub frame periods into a plurality of sub-sub frame periods,
the voltage application means applies to just one of the plurality of signal electrodes a voltage that makes the light extraction rate of the element corresponding to the selected scan electrode and that signal electrode be 100%, every sub-sub frame period, and
the light source control means controls the light source every sub-sub frame period so that light having an intensity in accordance with an amount of light extracted via the element that corresponds to the scan electrode and signal electrode to which the voltage is applied in that sub-sub frame period, is emitted from the light source just in that sub-sub frame period.

6. The dimming device according to claim 1, wherein the dividing means divides the one frame period into the sub frame periods of a number same as that of the plurality of scan electrodes.

7. The dimming device according to claim 1, wherein the light source emits light having a directivity traveling along a direction at right angles to the direction in which the light source is disposed.

8. The dimming device according to claim 1, wherein the light source is disposed on each of two opposing edges of the light guiding plate.

9. The dimming device according to claim 8, wherein the light source control means controls the two light sources so that the light is emitted simultaneously from the two light sources.

10. The dimming device according to claim 8, wherein the light source control means controls the two light sources every sub frame period, so that the light is emitted from a light source that is disposed closer to the scan electrode selected by the voltage application means in that sub frame period, out of the two light sources.

11. The dimming device according to claim 8, wherein the light source control means controls the two light sources so that the light is emitted alternately from one of the two light sources, every one frame period.

12. The dimming device according to claim 8, wherein the light source control means controls the two light sources so that the light is emitted alternately from one of the light sources, every sub frame period.

13. An image display device, comprising:
a dimming device as set forth in claim 1; and
a display panel disposed on a light exiting plane side of the dimming device.
